(19) United States
(12) Patent Application Publication
(10) Pub. No.: US 2018/0051831 A1
(43) Pub. Date: Feb. 22, 2018

(54) COMBINED-PIPELINE SYSTEMS

(71) Applicant: EDWARD GILBERT, CALGARY (CA)

(72) Inventor: EDWARD GILBERT, CALGARY (CA)

(21) Appl. No.: 15/240,867

(22) Filed: Aug. 18, 2016

(51) Int. Cl. F16L 9/19

(52) U.S. Cl. CPC F16L 9/19

(57) ABSTRACT

A combined-pipeline system including a plurality of combined-pipeline assemblies in both functional and structural combination. The combined-pipeline assemblies including an outer-conduit, an inner-conduit, and a plurality of carrier-supports. The outer-conduit including an inner-circumference, an outer-circumference, a first-end, and a second-end in functional and structural combination. The inner-conduit including an inside-circumference, an outside-circumference, a primary-end, and a secondary-end. The outside-circumference of the inner-conduit supports is located adjacent to and supported by the inside-surface of said plurality of carrier-supports. Each of the plurality of carrier-supports includes a retaining-ring and standoffs. The plurality of standoffs of the carrier-supports are preferably located adjacent to and supported by the inner-circumference of the outer-conduit. The combined-pipeline system is useful for carrying and transporting two fluid materials within a single pipeline.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of fluid transmission and more specifically relates to combined-pipeline systems.

### 2. DESCRIPTION OF RELATED ART

Pipeline transport is a common way to transport fluid materials such as water, petroleum products/fuels, food materials, chemicals, and waste. Generally, the fluids may be liquid, gas, slurry or any combination thereof. Pneumatic tubes using compressed air may also be used to transport solid capsules.

Oil and petroleum pipelines are generally made from steel or plastic which are usually buried, or may be suspended/supported above the ground. The material is usually moved through pipelines by pump and/or gravity. Pipelines conveying flammable or explosive material, such as natural gas or oil, pose special safety concerns.

In many cases, more than one material is desired to be transported via pipeline. In this case, a dedicated pipeline for each fluid material is needed. By using multiple pipelines a larger footprint is needed to place each pipe, as the pipes generally require spacing between pipes for safety and stability. Also, when pipes are buried, adequate backfill is required, also increasing the footprint and the cost of construction. Therefore a suitable solution is desired.

Several attempts have been made to solve the above-mentioned problems such as those found in U.S. and Foreign Pat. and Pub. Nos. US 2006/0207673 to O'Brien et al.; U.S. Pat. No. 6,264,401 to Langner et al.; U.S. Pat. No. 5,322,551 to Payne; U.S. Pat. No. 8,959,499 to Critsinelis et al.; U.S. Pat. No. 6,253,855 to Johal et al.; CA 2,495,647 to Gramme et al.; CA 1,290,263 to Ziu; and CA 2,611,115 to Dinon et al. This art is representative of fluid transmission. However, none of the above inventions and patents, taken either singly or in combination, is seen to describe the invention as claimed.

Preferably, a combined-pipeline system should provide a means to transport two different fluids by use of a single pipeline system therefore reducing pipeline construction time and conserving space needed when compared to a two-pipeline system and, yet would operate reliably and be manufactured at a modest expense. Thus, a need exists for a reliable combined-pipeline system to avoid the above-mentioned problems.

### BRIEF SUMMARY OF THE INVENTION

In view of the foregoing disadvantages inherent in the known fluid transmission art, the present invention provides a novel combined-pipeline system. The general purpose of the present invention, which will be described subsequently in greater detail is to provide a system useful for allowing the transport of two separate fluids using a single pipeline system, where a two-pipeline system would otherwise be required.

A combined-pipeline system is disclosed herein, in a preferred embodiment, comprising a plurality of combined-pipeline assemblies in both functional and structural combination. The combined-pipeline assemblies preferably comprise an outer-conduit, an inner-conduit, and a plurality of carrier-supports.

The outer-conduit preferably comprises an inner-circumference, an outer-circumference, a first-end, and a second-end in functional and structural combination. The inner-conduit preferably comprises an inside-circumference, an outside-circumference, a primary-end, and a secondary-end in functional and structural combination. The outside-circumference of the inner-conduit supports is preferably located adjacent to and supported by the inside-surface of said plurality of carrier-supports.

Additionally, each of the plurality of carrier-supports preferably comprises a retaining-ring (the retaining-ring comprising an inside-surface and an outside-surface) and a plurality of standoffs in functional and structural combination; each of the retaining-rings of the carrier-supports comprises the inside-surface, and outside-surface in functional and structural combination. The plurality of standoffs of the carrier-supports are preferably located adjacent to, and supported by, the inner-circumference of the outer-conduit.

In the preferred embodiment, the inner-conduit and the plurality of carrier-supports are contained within the outer-conduit. Also, a first-flow-space may be located, and defined by and between, the inner-circumference of the outer-conduit and the outside-circumference of the inner-conduit such that the first-flow-space is structured and arranged to carry and transport a first-fluid. Similarly, a second-flow-space is preferably defined by a volume encapsulated by the inside-circumference of the inner-conduit; and is structured and arranged to carry and transport a second-fluid.

In the preferred embodiment, each of the combined-pipeline assemblies are structured and arranged to carry the first-fluid and the second-fluid in a single-pipeline-system in order to reduce a need for a multiple pipelines required to carry multiple fluids (preferably two) from one location to another. Here, the first-fluid and the second-fluid are able to remain isolated from each other within the combined-pipeline system.

In the preferred embodiment, the combined-pipeline assembly further includes an outer-valve to provide access to the first-fluid, and includes an inner-valve to provide access to said second-fluid. Also, in the preferred embodiment, the retaining-ring(s) is/are constructed of multiple units, such that a plurality of the retaining-rings are able to be placed upon (and secured to) the inner-conduit individually by securing each of the multiple units together to form the (continuous) retaining-ring.

In the preferred embodiment, each retaining-ring(s) further comprises a plurality of bumpers, each of the plurality of bumpers may be affixable to each of the standoffs in order to increase friction to reduce (and preferably eliminate) lateral movement of the retaining-ring(s) within the combined-pipeline system.

Structurally speaking, each of said plurality of combined pipeline assemblies are preferably combined via a welding-process and each inner-conduit are preferably constructed from a metallic material to enhance strength and durability during use. Similarly, each outer-conduit is preferably constructed from a metallic material to enhance strength and durability during use. Also, each (of the plurality of) carrier-supports are constructed from a non-ferrous material to prevent conduction of static electricity between the outer-conduit and the outer-conduit.

Also disclosed herein, is a combined-pipeline kit. The kit may include a combined-pipeline assembly. The preferred embodiment of the combined-pipeline assembly includes (at least) one conduit-length of the outer-conduit, one length of the inner-conduit, and a plurality of carrier-supports, and a set of user instructions.

A method of using a combined-pipeline system is also disclosed, including the steps of: providing a plurality of combined-pipeline assemblies (comprising an outer-conduit, an inner-conduit, and a plurality of carrier-supports), coupling the plurality of combined-pipeline assemblies together to form a closed conduit, conveying two fluids (a first-fluid and a second-fluid) through the combined-pipeline system, delivering the first-fluid and the second-fluid from a first-location, and receiving the first-fluid and the second-fluid at a second-location. Additional steps preferably include removing the first-fluid and the second-fluid from the combined-pipeline system at the second-location, and decoupling the plurality of combined-pipeline assemblies from one another.

The present invention holds significant improvements and serves as a combined-pipeline system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, combined-pipeline systems, constructed and operative according to the teachings of the present invention.

FIG. 1 shows a perspective view illustrating a combined-pipeline system during an ‘in-use’ condition showing the combined-pipeline system used to transport more than one fluid according to an embodiment of the present invention.

FIG. 2 is a partial cutaway perspective view illustrating a combined-pipeline assembly of the combined-pipeline system comprising an outer-conduit, an inner-conduit, and a plurality of carrier-supports according to an embodiment of the present invention of FIG. 1.

FIG. 3 is a cutaway perspective view illustrating the arrangement of the outer-conduit, the inner-conduit, and the plurality of carrier-supports of the combined-pipeline assembly according to an embodiment of the present invention of FIGS. 1-2.

FIG. 4A-4C includes a perspective view, an axial view, and a side view, illustrating one of the plurality of carrier-supports of the combined-pipeline assembly according to an embodiment of the present invention of FIGS. 1-3.

FIG. 5 is a flowchart illustrating a method of use for a combined-pipeline system according to an embodiment of the present invention of FIGS. 1-4C.

The various embodiments of the present invention will hereinafter be described in conjunction with the appended drawings, wherein like designations denote like elements.

### DETAILED DESCRIPTION

As discussed above, embodiments of the present invention relate to a fluid transmission and more particularly to a combined-pipeline system as used to improve the ease of construction and the conservation of use of land required to transport multiple fluids via pipeline.

Generally speaking, a combined-pipeline system includes a plurality of combined-pipeline assemblies. Each of the plurality of combined-pipeline assemblies may include an outer-conduit, an inner-conduit, and a plurality of carrier-supports.

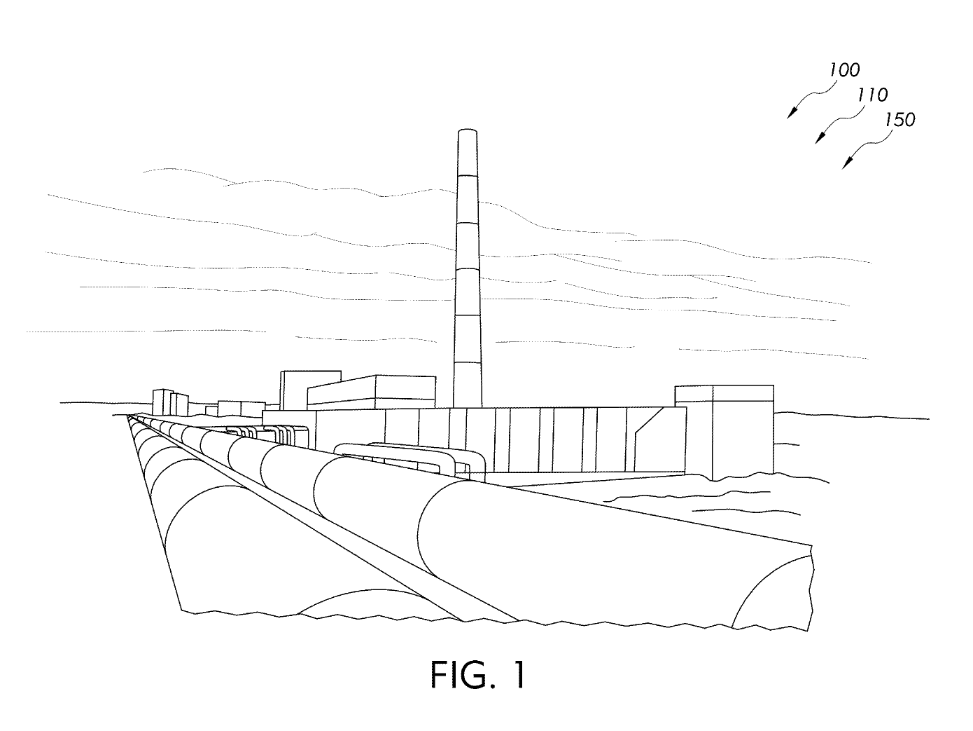

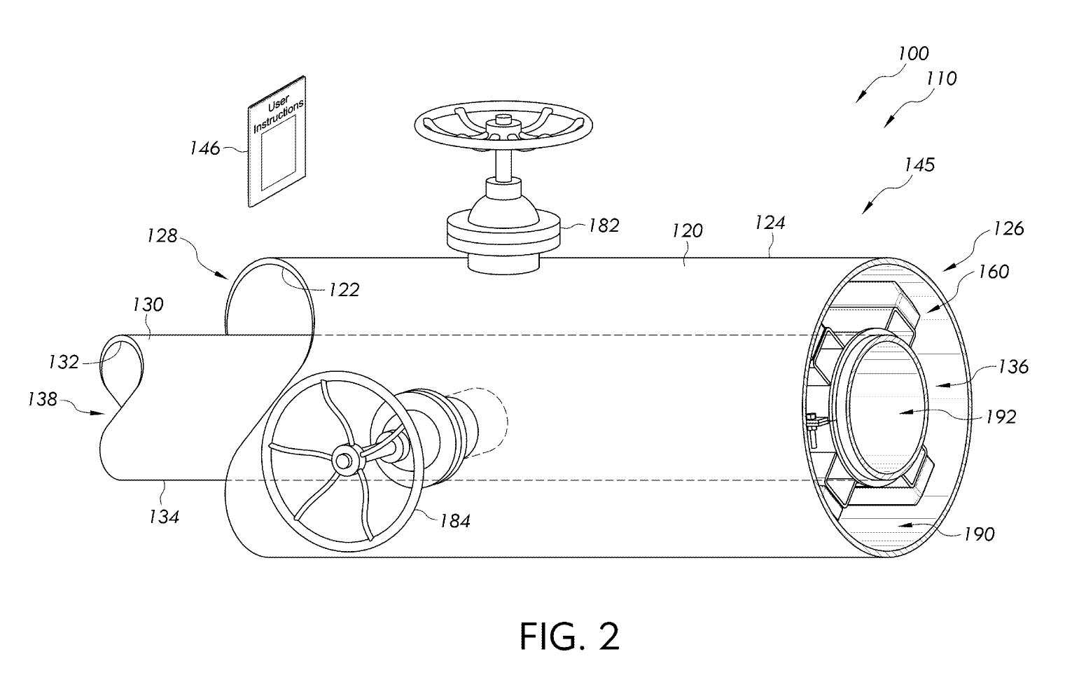

Referring to the drawings by numerals of reference there is shown in FIG. 1, combined-pipeline system 100 during ‘in-use’ condition 150 being used to transport fluid materials. As can be seen in FIG. 2, combined-pipeline system 100 may comprise outer-conduit 120, inner-conduit 130, and plurality of carrier-supports 160.

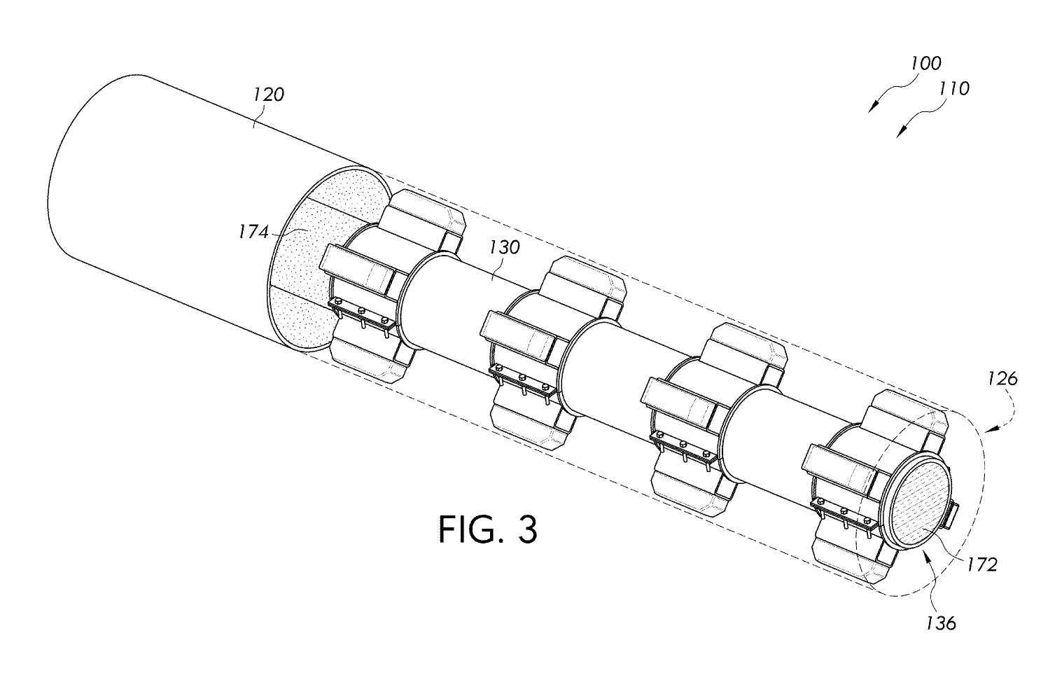

Referring now to FIGS. 2, 3 and 4A-4C, outer-conduit 120 may comprise inner-circumference 122, outer-circumference 124, first-end 126, and second-end 128 in both functional and structural combination. The outer-conduit 120 may have a circular-type cross-section. Inner-conduit 130 may comprise inside-circumference 132, outside-circumference 134, primary-end 136, and secondary-end 138 in both functional and structural combination. Similar to outer-conduit 120, inner-conduit 130 may also be circular in cross-section.

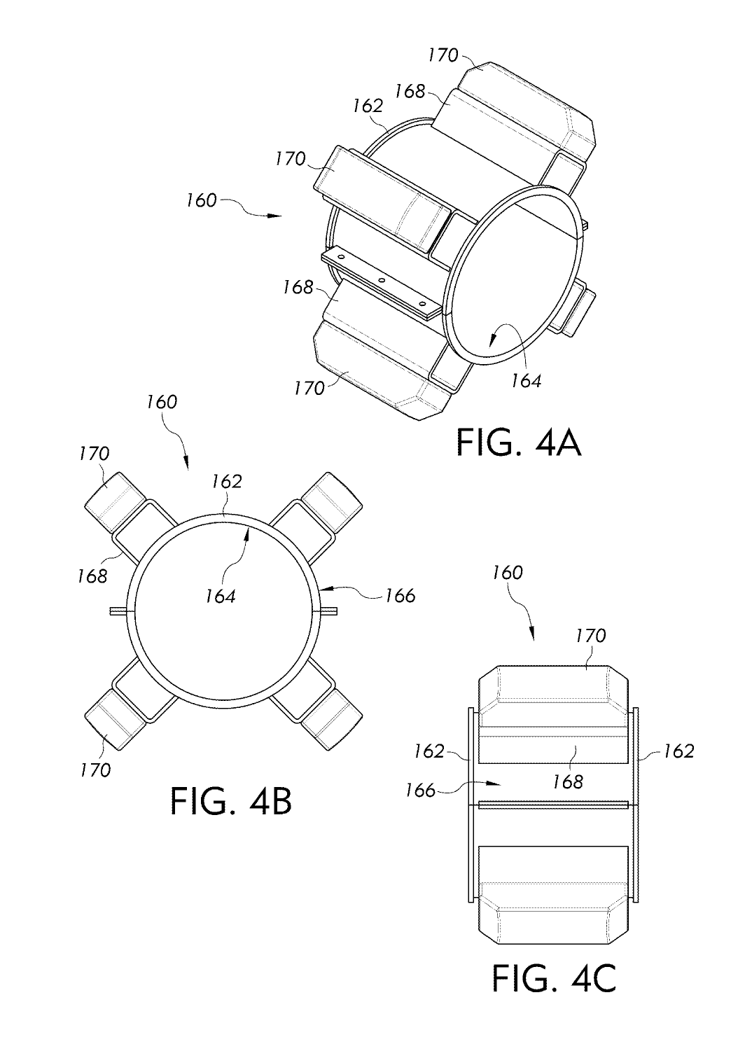

Referring now more particularly to FIG. 4A-4C, plurality of carrier-supports 160 may (each) comprise retaining-ring 162. Retaining-ring 162 may comprise inside-surface 164, outside-surface 166, and a plurality of standoffs 168, all of which may be functionally and structurally combined.

Referring now to FIGS. 2-4C, standoffs 168 of carrier-support 160 may each be located adjacent to, and supported by, inner-circumference 122 of outer-conduit 120. Also, outside-circumference 134 of inner-conduit 130 may be located adjacent to, and supported by, inside-surface 164 of plurality of carrier-supports 160. Inner-conduit 130 and plurality of carrier-supports 160 may be contained within outer-conduit 120.

First-flow-space 190 may be located, and defined by the generally annular region between the inner-circumference 122 of outer-conduit 120 and the outside-circumference 134 of inner-conduit 130 and may be structured and arranged to carry and transport first-fluid 172. Second-flow-space 192 may be located and defined by a generally cylindrical volume bound by inside-circumference 132 of inner-conduit 130, and may be structured and arranged to carry and transport second-fluid 174. Some embodiments may further include outer-valve 182 to provide access to first-fluid 172 and inner-valve 184 to provide access to second-fluid 174.

Each of combined-pipeline assemblies 110 may be structured and arranged to carry first-fluid 172 and second-fluid 174 in a single-pipeline-system in order to reduce a need for multiple pipelines to carry multiple fluids from one location to another. Moreover, first-fluid 172 and second-fluid 174 are able to remain isolated from each other.

Retaining-ring 162 may be constructed of a single unit such that a plurality of retaining-rings 162 may be able to be placed upon inner-conduit 130 one at a time, in a coaxial fashion. In other embodiments, retaining-ring(s) 162 may be constructed of separable units, such that retaining-ring(s) 162 are able to be placed upon inner-conduit 130 individually by securing each of the separable units together to form a single retaining-ring 162.

Retaining-ring 162 may further include a plurality of bearings, each of plurality of bearings affixable to each of plurality of standoffs 168 to reduce friction when retaining-ring 162 is inserted into outer-conduit 120. Alternately, each retaining-ring 162 may further comprise bumper(s) 170 affixable to each standoff 168 to increase friction in order to reduce radial movement of retaining-ring 162 within combined-pipeline assembly 110.

During construction, assembly, deconstruction, or disassembly, combined-pipeline system 100 may include plurality of combined pipeline assemblies 110, combined via flanges. Alternately, or cumulatively, each of plurality of combined-pipeline assemblies 110 may also be combined via a welding-process. Also, combined-pipeline assemblies 110 may combined via threaded-coupling. Friction-fit (e.g., bell and spigot, gasket, ring-lock, etc.) may also be a suitable method for adjoining combined-pipeline assemblies 110.

When considering construction materials, inner-conduit 130 may be constructed from a metallic material to enhance strength and durability during use, and outer-conduit 120 may be constructed from a similar metallic material to enhance strength and durability during use. Alternately, inner-conduit 130 may be constructed from plastic-material to provide corrosion resistance during use, and outer-conduit 120 may also be constructed from plastic-material to provide corrosion resistance during use. Plurality of carrier-supports 160 may be constructed from a non-ferrous material to prevent conduction of static electricity between outer-conduit 120 and inner-conduit 130.

It should be noted that combined-pipeline system 100 may be sold as a kit 145 comprising the following parts: at least one combined-pipeline assembly 110 (including: at least one at least one conduit-length of outer-conduit 120, at least one length of inner-conduit 130, and at least one carrier-support 160); and at least one set of user instructions 146. The kit 145 has instructions such that functional relationships are detailed in relation to the structure of the invention (such that the invention can be used, maintained, or the like in a preferred manner).

Combined-pipeline system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements (for example, including more or less components, customized parts, different fastening combinations, parts may be sold separately, etc.) may be sufficient.

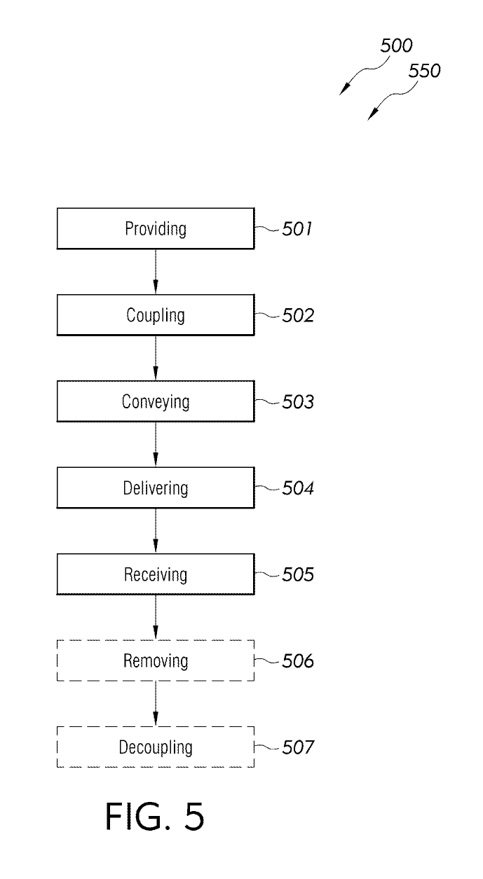

Referring now to FIG. 5 showing flowchart 550 illustrating method of use 500 for combined-pipeline system 100 according to an embodiment of the present invention of FIGS. 1-4C. As shown, method of use 500 may comprise the steps of: step one 501, providing plurality of combined-pipeline assemblies 110 (including outer-conduit 120, inner-conduit 130, and carrier-supports 160); step two 502, coupling combined-pipeline assemblies 110 together to form a closed conduit; step three 503, conveying two fluids through combined-pipeline system 100; step four 504, delivering first-fluid 172 and second-fluid 174 from a first-location; step five 505, receiving first-fluid 172 and second-fluid 174 at a second-location (first-fluid 172 and second-fluid 174 remaining isolated from each other); step six 506, removing first-fluid 172 and second-fluid 174 from combined-pipeline system 100; and step seven 507, decoupling plurality of combined-pipeline assemblies 110 from one another.

It should be noted that step six 506 and step seven 507 are optional steps and might not be implemented in all cases. Optional steps of method of use 500 are illustrated using dotted lines in FIG. 5 so as to distinguish them from the other steps of method of use 500.

It should be noted that the steps described in the method of use can be carried out in many different orders according to user preference. The use of “step of” should not be interpreted as “step for”, in the claims herein and is not intended to invoke the provisions of 35 U.S.C. §112(f). Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A combined-pipeline system comprising:
a plurality of combined-pipeline assemblies including
an outer-conduit having
an inner-circumference,
an outer-circumference,
a first-end, and
a second-end;
an inner-conduit having
an inside-circumference,
an outside-circumference,
a primary-end, and
a secondary-end; and
a plurality of carrier-supports each including
a retaining-ring having an inside-surface and an outside-surface, and
a plurality of standoffs;
wherein said outer-conduit, said inner-conduit, and said plurality of carrier-supports of each of the plurality of combined-pipeline assemblies are in functional and structural combination with each other;
wherein said inner-circumference, said outer-circumference, said first-end, and said second-end are in functional and structural combination with each other;
wherein said inside-circumference, said outside-circumference, said primary-end, and said secondary-end are in functional and structural combination with each other;
wherein said retaining-ring and said plurality of standoffs are in functional and structural combination with each other;
wherein said inside-surface and outside-surface are in functional and structural combination with each other;
wherein said plurality of standoffs of said carrier-supports are located adjacent to and supported by said inner-circumference of said outer-conduit;
wherein said outside-circumference of said inner-conduit is located adjacent to and supported by said inside-surface of said plurality of carrier-supports;
wherein said inner-conduit and said plurality of carrier-supports are contained within said outer-conduit;
wherein a first-flow-space is defined by and located between said inner-circumference of said outer-conduit and said outside-circumference of said inner-conduit is structured and arranged to carry and transport a first-fluid;
wherein a second-flow-space is located and defined by a volume encapsulated by said inside-circumference of said inner-conduit is structured and arranged to carry and transport a second-fluid; and
wherein each of said combined-pipeline assemblies are structured and arranged to carry said first-fluid and said second-fluid in a single-pipeline-system while isolating said first-fluid and said second-fluid from each other.

2. The combined-pipeline system of claim 1, wherein each of said combined-pipeline assemblies further includes an outer-valve configured to provide access to said first-fluid.

3. The combined-pipeline system of claim 1, wherein each of said combined-pipeline assemblies further includes an inner-valve configured to provide access to said second-fluid.

4. The combined-pipeline system of claim 1, wherein said retaining-ring is constructed of a single unit.

5. The combined-pipeline system of claim 1, wherein said retaining-ring is separated into a plurality units, the plurality of units configured to be assembled about said inner-conduit by securing each of said plurality of units together to form said retaining-ring.

6. The combined-pipeline system of claim 1, wherein said retaining-ring further comprises a plurality of bearings, each of said plurality of bearings affixable to each of said plurality of standoffs, said plurality of bearings configured to reduce friction when said retaining-ring is inserted into said outer-conduit.

7. The combined-pipeline system of claim 1, wherein each of said plurality of carrier-supports further includes a plurality of bumpers, each of said plurality of bumpers affixable to each of said plurality of standoffs and configured to increase friction and reduce radial movement of said plurality of carrier-supports within each of said plurality of said combined-pipeline assemblies.

8. The combined-pipeline system of claim 1, wherein each of said plurality of combined-pipeline assemblies are combined via flanges.

9. The combined-pipeline system of claim 1, wherein said wherein each of said plurality of combined-pipeline assemblies are combined via weld.

10. The combined-pipeline system of claim 1, wherein said wherein each of said plurality of combined-pipeline assemblies are combined via threaded-coupling.

11. The combined-pipeline system of claim 1, wherein said wherein each of said plurality of combined-pipeline assemblies are combined via friction-fit.

12. The combined-pipeline system of claim 1, wherein said inner-conduit is constructed from a metallic material configured to enhance strength and durability during use.

13. The combined-pipeline system of claim 1, wherein said outer-conduit is constructed from a metallic material configured to enhance strength and durability during use.

14. The combined-pipeline system of claim 1, wherein said inner-conduit is constructed from plastic material configured to provide corrosion resistance during use.

15. The combined-pipeline system of claim 1, wherein said outer-conduit is constructed from plastic material configured to provide corrosion resistance during use.

16. The combined-pipeline system of claim 1, wherein said plurality of carrier-supports are constructed of a non-ferrous material configured to prevent conduction of static electricity between said outer-conduit and said inner-conduit.

17. A combined-pipeline system comprising:
a plurality of combined-pipeline assemblies including
an outer-conduit having
an inner-circumference,
an outer-circumference,
a first-end, and
a second-end;
an inner-conduit having
an inside-circumference,
an outside-circumference,
a primary-end, and
a secondary-end;
a plurality of carrier-supports each including
a retaining-ring having an inside-surface and an outside-surface; and
a plurality of standoffs;
wherein said outer-conduit, said inner-conduit and said plurality of carrier-supports of each of the plurality of combined-pipeline assemblies are in functional and structural combination with each other;
wherein said inner-circumference, said outer-circumference, said first-end, and said second-end are in functional and structural combination with each other;
wherein said inside-circumference, said outside-circumference, said primary-end, and said secondary-end are in functional and structural combination with each other;
wherein said retaining-ring, and said plurality of standoffs are in functional and structural combination with each other;
wherein said inside-surface and outside-surface are in functional and structural combination with each other;
wherein said plurality of standoffs of said carrier-supports are located adjacent to and supported by said inner-circumference of said outer-conduit;
wherein said outside-circumference of said inner-conduit is located adjacent to and supported by said inside-surface of said plurality of carrier-supports;
wherein said inner-conduit and said plurality of carrier-supports are contained within said outer-conduit;
wherein a first-flow-space is defined by and located between said inner-circumference of said outer-conduit and said outside-circumference of said inner-conduit is structured and arranged to carry and transport a first-fluid;
wherein a second-flow-space defined by a volume encapsulated by said inside-circumference of said inner-conduit is structured and arranged to carry and transport a second-fluid;
wherein each of said combined-pipeline assemblies are structured and arranged to carry said first-fluid and said second-fluid in a single-pipeline-system isolating said first-fluid and said second-fluid from each other;
wherein each of said combined-pipeline assemblies further includes an outer-valve configured to provide access to said first-fluid;
wherein each of said combined-pipeline assemblies further includes an inner-valve configured to provide access to said second-fluid;
wherein said retaining-ring is separated into a plurality units, the plurality of units configured to be assembled about said inner-conduit by securing each of said plurality of units together to form said retaining-ring;
wherein each of said plurality of carrier-supports further includes a plurality of bumpers, each of said plurality of bumpers affixable to each of said plurality of standoffs and configured to increase friction and reduce radial movement of said plurality of carrier-supports within each of said plurality of said combined-pipeline assemblies;
wherein said wherein each of said plurality of combined pipeline assemblies are combined via weld;
wherein said inner-conduit is constructed from a metallic material configured to enhance strength and durability during use;
wherein said outer-conduit is constructed from a metallic material configured to enhance strength and durability during use; and
wherein said plurality of carrier-supports are constructed of a non-ferrous material configured to prevent conduction of static electricity between said outer-conduit and said outer-conduit.

18. The combined-pipeline system of claim 17, further comprising a set of user instructions; and
wherein the combined-pipeline system is configured as a kit.

19. A method of using a combined-pipeline system, the method comprising the steps of:
providing a plurality of combined-pipeline assemblies including an outer-conduit, an inner-conduit, and a plurality of carrier-supports;
coupling said plurality of combined-pipeline assemblies together to form a closed conduit;
conveying two fluids through said combined-pipeline system, with a first-fluid carried within a first-flow-space defined by and between said outer-conduit and said inner-conduit, and a second-fluid carried within a second-flow-space defined by an area bound by said inner-conduit;
delivering said first-fluid and said second-fluid from a first-location; and
receiving said first-fluid and said second-fluid at a second-location, said first-fluid and said second-fluid remaining isolated from each other.

20. The method of claim 19, further comprising the steps of:
removing said first-fluid and said second-fluid from said combined-pipeline system; and
decoupling said plurality of combined-pipeline assemblies from one another.
